(19) United States
(12) Patent Application Publication
(10) Pub. No.: US 2010/0303507 A1
(43) Pub. Date: Dec. 2, 2010

(54) DEVELOPING APPARATUS AND IMAGE FORMING APPARATUS

(75) Inventor: Tatsuya ISONO, Toyokawa-shi (JP)

Correspondence Address: BUCHANAN, INGERSOLL & ROONEY PC, POST OFFICE BOX 1404, ALEXANDRIA, VA, 22313-1404, US

(73) Assignee: KONICA MINOLTA BUSINESS TECHNOLOGIES, INC., Tokyo (JP)

(21) Appl. No.: 12/786,773

(22) Filed: May 25, 2010

(30) Foreign Application Priority Data
May 28, 2009 (JP) 2009-128977

(51) Int. Cl. G03G 15/08

(52) U.S. Cl. 399/254

(57) ABSTRACT

A developing apparatus is provided with a developer accommodating container having a replenishing portion in which a developer including a toner and a carrier is accommodated, and provided for replenishing the developer, and a discharging portion for discharging the accommodated developer. The developer accommodating container is separated into a first accommodating portion and a second accommodating portion by a partition wall, and the first accommodating portion and the second accommodating portion are communicated with each other by communication portions in both end sides. The developing apparatus moves in a circulating manner the accommodated developer while agitating, by means of a first feeding member arranged in the first accommodating portion and a second feeding member arranged in the second accommodating portion. The communication portions are communicated below a supposed lowest height of a liquid surface of the developer.

This application is based on Japanese Patent Application No. 2009-128977 filed in Japan on May 28, 2009, the entire content of which is hereby incorporated by reference.

### BACKGROUND OF THE INVENTION

1. Field of the Invention

The present invention relates to a developing apparatus and an image forming apparatus.

2. Description of the Related Art

Conventionally, there has been known a developing apparatus structured, for example, such as to move in a circulating manner a developer accommodated in a developer accommodating chamber while agitating, by dividing the developer accommodating chamber by a partition wall except inflow portions (communication portions) in both ends and arranging a screw in each of the formed accommodating chambers (for example, refer to Japanese Unexamined Patent Publication No. 2008-250290).

However, in the conventional developing apparatus mentioned above, one communication portion (a first communication portion) positioned in a discharge side of the developer is formed in a center portion in a height direction. Further, the remaining other communication portion (a second communication portion) comes to a full-open state having no partition wall. On the other hand, a liquid surface of the developer fluctuates on the basis of a change of a feeding speed of the developer, or an inclination of the developing apparatus. Accordingly, in the first communication portion, in the case that the liquid surface position of the developer becomes lower than a lower end of an opening of the communication portion, it is impossible to make the developer flow from the one accommodating chamber to the other accommodating chamber. Further, in the second communication portion, it is impossible to limit an amount of the flowing developer. As a result, a dispersion of an amount of the developer becomes large in a circulating direction of the developer, thereby causing an image unevenness, and generating such a problem that a torque load applied to the screw is increased or decreased.

### SUMMARY OF THE INVENTION

An object of the present invention is to provide a developing apparatus and an image forming apparatus which can inhibit an image unevenness from being generated, and inhibit a torque load applied to a screw from being increased or decreased, by stabilizing a circulating state of a developer.

In accordance with one aspect of the present invention, there is provided a developing apparatus including:

a developer accommodating container having a replenishing portion in which a developer including a toner and a carrier is accommodated, and provided for replenishing the developer, and a discharging portion for discharging the accommodated developer; the developer accommodating container being separated into a first accommodating portion and a second accommodating portion by a partition wall; the first accommodating portion and the second accommodating portion being communicated with each other by communication portions in both end sides; and the developing apparatus being structured such as to move in a circulating manner the accommodated developer while agitating, by means of a first feeding member arranged in the first accommodating portion and a second feeding member arranged in the second accommodating portion,

wherein the communication portions are communicated below a supposed lowest height of a liquid surface of the developer.

In accordance with this structure, since the developer is structured such as to be always positioned above the upper end of the opening of the communication portion, even if the position of the liquid surface of the developer fluctuates, the amount of the developer flowing from the one accommodating portion to the other accommodating portion is not affected by the fluctuation of the position of the liquid surface. Accordingly, it is possible to suppress the fluctuating amount of the developer in the circulating direction, and it is possible to prevent the image unevenness and the fluctuation of the torque load applied to each of the feeding members.

In the above aspect, each of the first feeding member and the second feeding member are constructed by a screw in which a spiral blade is provided around a rotating shaft, and

wherein the communication portion is an opening formed in the partition wall, and a position of an opening upper end of the communication portion is positioned in a lower side with respect to a straight line connecting centers of rotation of the feeding members.

In the above aspect, a discharge portion of the developer accommodating container is arranged in a downstream side in a feeding direction of the developer by any one of the feeding members,

wherein the feeding member is provided with a backflow portion flowing back a feeding direction of the developer in an upstream side of the discharge portion with respect to the feeding direction of the developer, and

wherein the communication portion formed in the discharge portion side is formed in a further upstream side of the backflow portion.

In accordance with this structure, since the reduction of the liquid surface of the developer can be suppressed by the backflow portion of the feeding member in the vicinity of the communication portion, it is possible to prevent a lack of flowing of the developer in the communication portion in cooperation with the structure mentioned above.

In the above aspect, an angle which a straight line connecting centers of rotation of the feeding members forms with respect to a horizontal surface is set to be equal to or less than 30 degrees.

In accordance with this structure, it is possible to suppress the amount at which the developer moves in the communication portion due to its own weight.

In the above aspect, the position of the opening lower end of at least one communication portion which is positioned at the side of the discharging portion in the communication portions is upper to the lowest position of the each accommodating portion.

In accordance with this structure, it is possible to make the flowing state of the developer in the communication portions smoother.

In the above aspect, the position of the opening lower end of the communication portion is set to the same position as the lowest positions of the accommodating portions.

In accordance with this structure, it is possible to make the flowing state of the developer in the communication portions more smoothly.

Further, there is provided an image forming apparatus which is provided with the developing apparatus described in any one of the aspects mentioned above, as a means for solving the problem mentioned above.

### BRIEF DESCRIPTION OF THE DRAWINGS

FIG. 1 is a schematic explanatory view of an image forming apparatus in accordance with the present embodiment;

FIG. 2 is a front elevational cross sectional view of a developing apparatus in FIG. 1;

FIG. 3 is a vertical cross sectional view of a developer accommodating container in FIG. 2;

FIG. 4 is a partial exploded perspective view showing a part of the developer accommodating container in FIG. 2;

FIG. 5 is a horizontal cross sectional view in a communication portion of the developer accommodating container in FIG. 2;

FIG. 6 is a vertical cross sectional view of a developer accommodating container in accordance with the other embodiment; and

FIG. 7 is a horizontal cross sectional view in a communication portion of the developer accommodating container in accordance with the other embodiment.

FIG. 8 is a horizontal cross sectional view in a communication portion of the developer accommodating container in accordance with the other embodiment.

### DETAILED DESCRIPTION OF THE PREFERRED EMBODIMENTS

A description will be given below of an embodiment in accordance with the present invention with reference to the accompanying drawings. In this case, in the following description, a kind, a combination, a shape, a relative arrangement and the like of the constructing elements do not limit a technical range of the present invention to them as far as any specific description is not given. Further, terms (for example, “upper”, “lower”, “one end”, “other end” and the like) indicating specific directions and positions are appropriately used as occasion demands, however, these terms are used for facilitating the understanding of the invention with reference to the drawings, and the technical range of the present invention is not limited by the meanings of the terms. Further, the following description is essentially given only for exemplifying, and does not intend to limit the present invention, an applied material thereof or an intended use thereof.

### (1. Whole Construction)

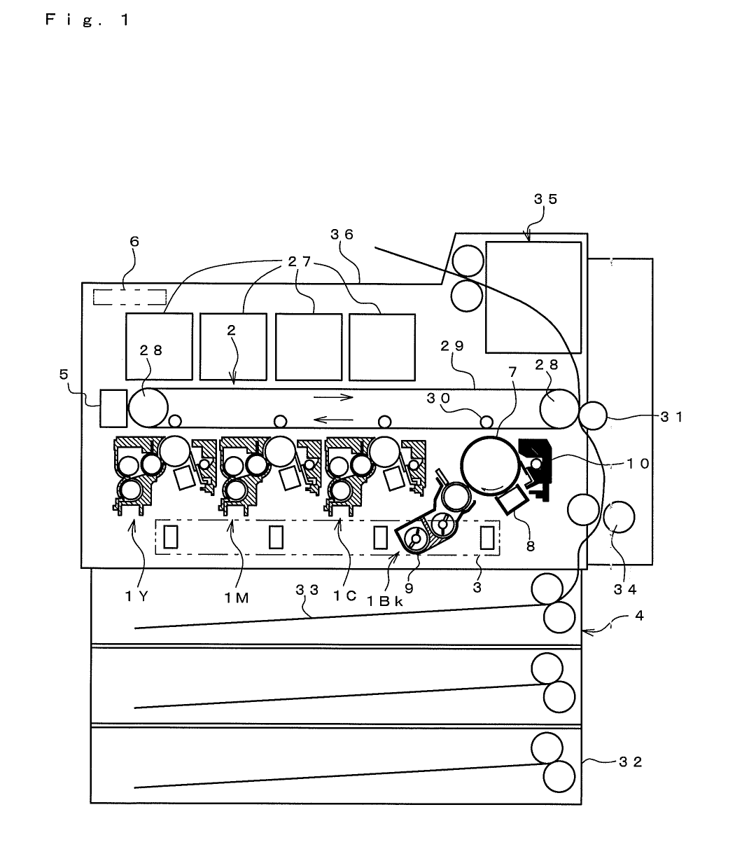

FIG. 1 shows an image forming apparatus according to the present embodiment. The image forming apparatus is generally provided with an image forming unit 1Y, 1M, 1C and 1Bk, a transfer unit 2, an exposure unit 3, a recording medium feeding unit 4, a cleaning unit 5, a control unit 6 and the like.

The image forming units 1Y, 1M, 1C and 1Bk are arranged at four positions along an intermediate transfer belt 29 of the transfer unit 2, and form a color image on a surface of the intermediate transfer belt 29 by respectively carrying out an image formation of yellow (Y), magenta (M), cyan (C) and black (Bk) from a left side. Each of the image forming units 1Y, 1M, 1C and 1Bk is provided with a charging apparatus 8, a developing apparatus 9, a cleaning apparatus 10 and the like around a photoreceptor drum 7.

The charging apparatus 8 forms a predetermined surface potential on a surface of the photoreceptor drum 7. The surface potential comes to an electrostatic latent image by being exposed by the exposure unit 3.

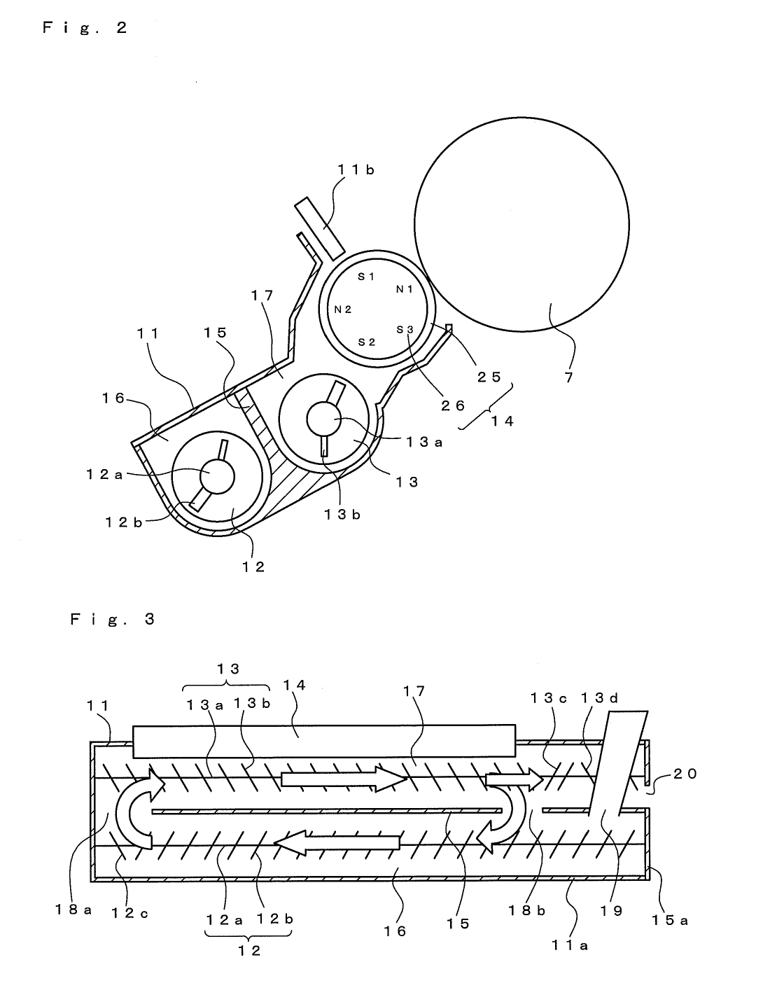

The developing apparatus 9 is structured, as shown in FIGS. 2 and 3, such that each of an agitating screw 12, a feeding screw 13 and a developing roller 14 is accommodated within a developer accommodating container 11. The developing apparatus 9 is a standard developing apparatus using a two-component developer in the image forming apparatus 1Y, 1M and 1C. Meanwhile, in the image forming apparatus 1Bk, a so-called trickle type image forming apparatus structured such as to replenish a developer including a carrier in addition to a toner is used. In this case, a detailed structure of the developing apparatus 9 will be mentioned below.

A developer replenishing container 27 is detachably provided above the developing apparatus 9, as shown in FIG. 1, the developer replenishing container 27 replenishing a two-component developer for replenishing (hereinafter, refer simply to as a developer) constituted by a toner and a carrier.

The cleaning apparatus 10 cleans the toner staying in the surface of the photoreceptor drum 7 after being transferred to the surface thereof.

The transfer unit 2 is structured such that an intermediate transfer belt 29 is bridged over a pair of support rollers 28, the support rollers 28 are driven by a driving means (not shown), and the intermediate transfer belt 29 is moved in a circulating manner in a direction of an arrow, and is provided with a primary transfer portion 30 and a secondary transfer portion 31.

The exposure unit 3 irradiates a laser light to the photoreceptor drum 7, and forms an electrostatic latent image corresponding to an image data read by a scanner (not shown).

The recording medium feeding unit 4 feeds a recording medium 33 accommodated in a cassette 32 to a secondary transfer portion 31 via a feed roller 34 sequentially. The toner image is transferred to the recording medium 33 fed to the secondary transfer portion 31, and the toner image transferred by a fixing unit 35 is fixed, and the recording medium 33 is thereafter carried out to a discharge tray 36.

The cleaning unit 5 can come close to and away from the intermediate transfer belt 29, and is structured such as to recover the toner staying in the intermediate transfer belt 29 by coming close thereto.

The control unit 6 executes a replenishing process of the developer on the basis of a detected voltage input from a magnetic permeability sensor (not shown) provided within the developer accommodating container 11.

### (2. Developing Apparatus)

A description will be in detail given below of a structure of the developing apparatus 9 (a structure in which each of the agitating screw 12, the feeding screw 13 and the developing roller 14 is accommodated within the developer accommodating container 11).

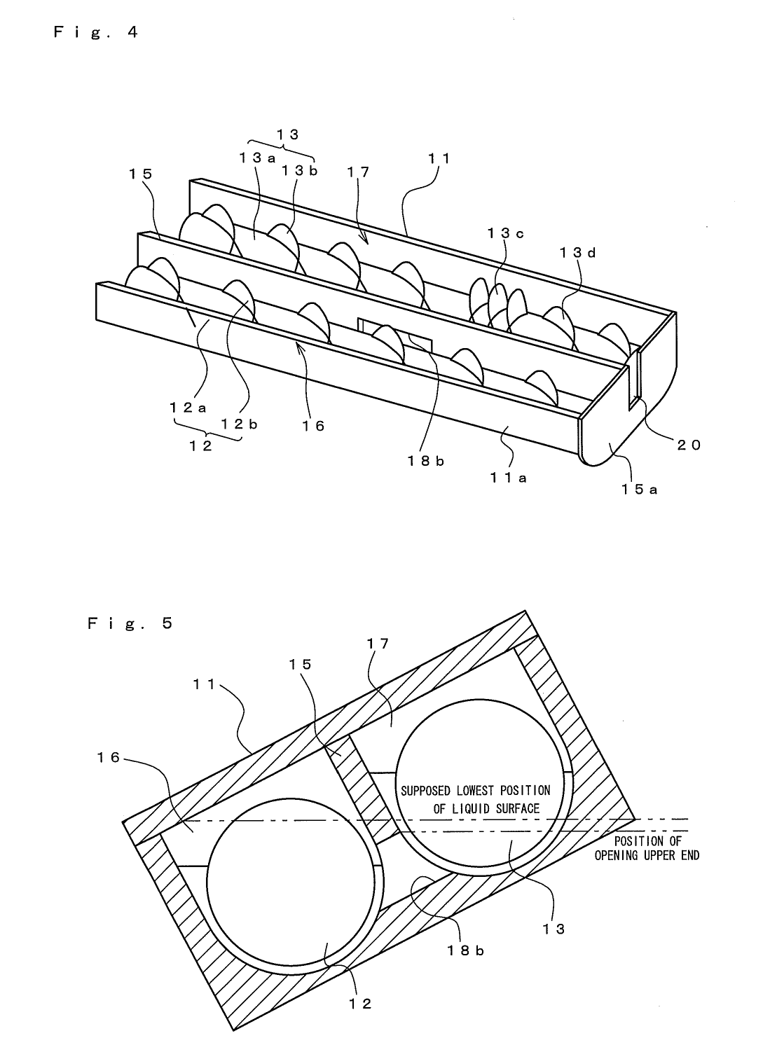

In other words, the developer accommodating container 11 is formed as a long box shape extending from one end side to the other end side, as shown in FIG. 3. The developer accommodating container 11 is provided with a container main body 11a, and a partition wall 15 dividing an inner portion of the container main body 11a into two sections including a first accommodating portion 16 and a second accommodating portion 17 along a longitudinal direction. One end side of the developer accommodating container 11 is open. The partition wall 15 is formed as an approximately T-shaped form by a closing plate 15a being integrated in one end thereof, as shown in FIG. 4. In the developer accommodating container 11, the agitating screw 12 is accommodated in the first accommodating portion 16 and the feeding screw 13 is accommodated in the second accommodating portion 17, respectively. The partition wall 15 is inserted from one end opening of the developer accommodating container 11 in a state in which both the screws 12 and 13 are accommodated, and the developer accommodating container 11 is completed by closing the one end opening by the closing plate 15a. As mentioned above, since the partition wall 15 is formed as approximately the T-shaped form by being integrated with the one end wall 15a, an assembling characteristic is improved. Further, since it is sufficient to form a notch for constructing communication portions 18a and 18b in the partition wall 15 and for constructing a developer discharge port 20 in the one end wall 15a, an excellent workability can be obtained. A bottom surface side of each of the accommodating portions 16 and 17 is formed as a circular arc-shaped cross section along an outer periphery of each of the screws 13 and 14 which are accommodated therein, as mentioned blow. Both end sides of the first accommodating portion 16 and the second accommodating portion 17 are communicated respectively by the communication portions 18a and 18b, and the accommodated developer is structured such as to move in a circulating manner while being agitated. The developer accommodating container 11 is arranged diagonally in such a manner that the second accommodating portion 17 is positioned in an upper side with respect to the first accommodating portion 16. It is preferable to set an angle of slope of the developer accommodating container 11 to a range between 0 degree and 30 degrees with respect to a horizontal surface, and the angle is set to 30 degree in this case. Further, a content of the developer accommodating container 11 is set to 230 cm³, and an amount of the accommodated developer is set between 160 and 290 g. Since a bulk density of the developer is 1.65 g/cm³, a volumetric capacity of the accommodated developer comes to 100 to 175 cm³ (about 140 cm³ in standard).

A developer replenishing port 19 is formed in one end side of the first accommodating portion 16, as shown in FIG. 3, and the developer is replenished from the corresponding developer replenishing container 27. However, only a toner is replenished from the image forming apparatus 1Y, 1M and 1C, and a two-component developer including a toner and a carrier is replenished from the image forming apparatus 1Bk. In this case, an external additive agent may be further included in the developer. Further, the developer discharge port 20 as mentioned above is formed in the one end wall 15a constructing one end side of the second accommodating portion 17.

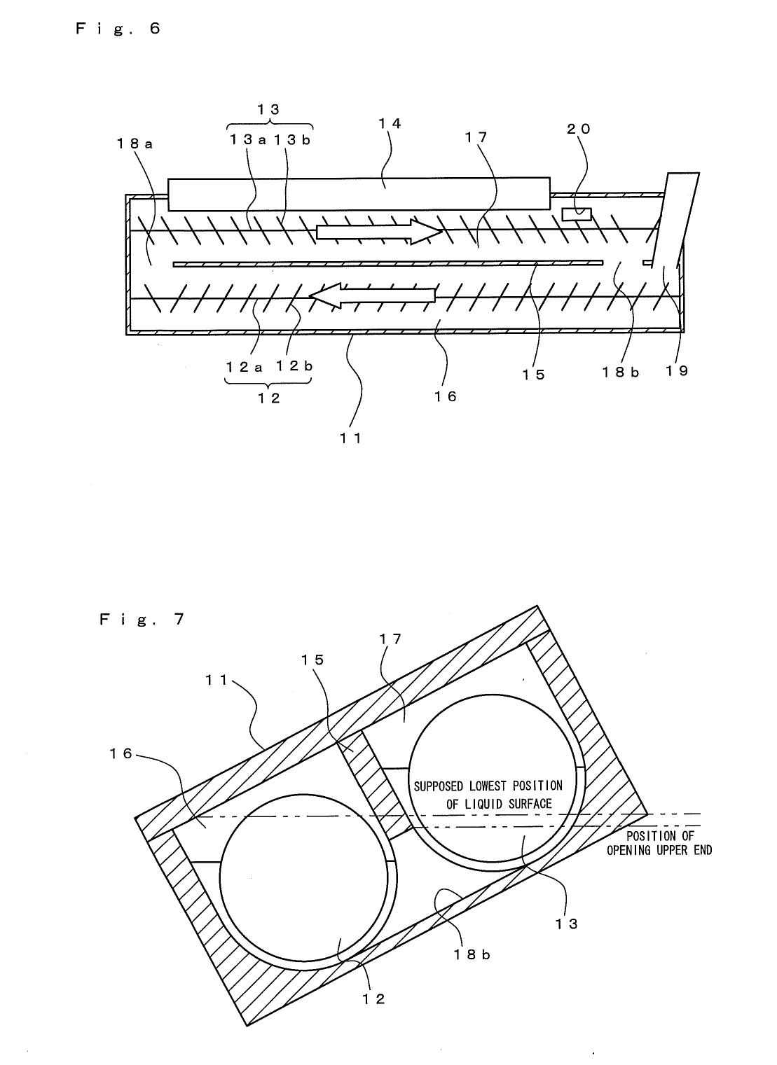

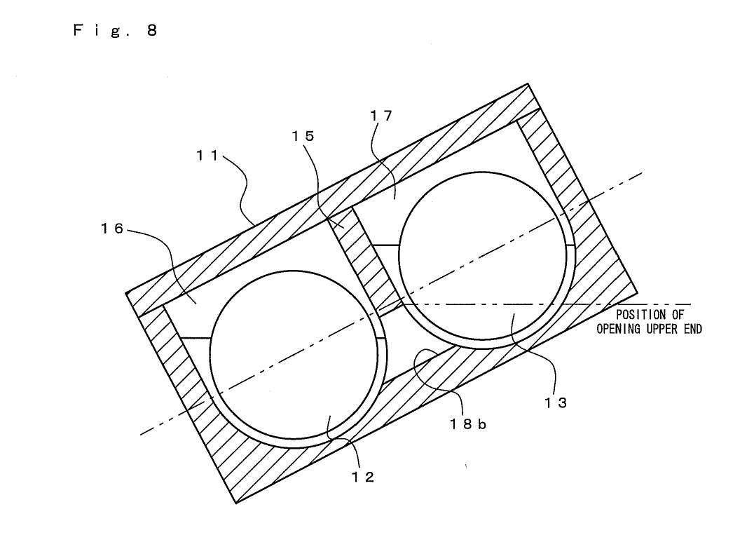

The communication portions 18a and 18b are both end portions of the partition wall 15, and correspond to a rectangular opening formed by cutting an approximately lower half portion as shown in FIG. 5. The communication portions 18a and 18b are formed in such a manner that an upper end of the opening is positioned in a lower side with respect to a position of a liquid surface of the developer accommodated within the developer accommodating container 11. Further, the opening lower ends of the communication portions 18a and 18b are formed to be above the lowest position of each of the accommodating portions 16 and 17. Furthermore, both of the communication portions 18a and 18b are formed to be positioned in the lower side than the supposed height of the liquid surface of the developer. In this case, the communication portions 18a and 18b can form various shapes such as a rectangular shape, an oval shape and the like. Further, the number thereof is not limited to one, but may be plural number.

The agitating screw 12 is structured, as shown in FIGS. 3 and 4, such that spiral blades 12b and 12c are provided around the rotating shaft 12a. The agitating screw 12 is inserted into the first accommodating portion 16 from the one end opening of the developer accommodating container 11. The blades 12b and 12c are formed in such a manner that spiral directions are inverted. Further, on the basis of a rotational drive of the agitating screw 12, the blade 12b agitates the developer while feeding from the communication portion 18b side to the communication portion 18a side. Further, the blade 12c makes the developer fed by the blade 12b flow back, and flow to the second accommodating portion 17 via the communication portion 18a.

The feeding screw 13 is structured, as shown in FIGS. 3 and 4, such that spiral blades 13b, 13c and 13d are provided around a rotating shaft 13a. The feeding screw 13 is inserted into the second accommodating portion 17 from the one end opening of the developer accommodating container 11, in the same manner as the agitating screw 12. The blade 13c is formed in such a manner that its spiral direction is inverted to that of the blades 13b and 13d. Further, on the basis of a rotational drive of the feeding screw 13, the blade 13b feeds the developer from the communication portion 18a side to the communication portion 18b side, and feeds it to the developing roller 14. Further, the blade 13c is positioned in a downstream side of the communication portion 18a in an upper stream side of the developer discharge port 20, with respect to a feeding direction of the developer by the blade 13b. Accordingly, the blade 13c applies an inverted force to the developer fed by the blade 13b so as to limit an amount discharged to the developer discharge port 20, and makes the developer flow into the first accommodating portion 16 via the communication portion 18a. Further, the blade 13d discharges the developer getting over the blade 13c to the developer discharge port 20.

The developing roller 14 is structured, as shown in FIG. 2, such that a plurality of permanent magnets 26 are accommodated within a cylindrical sleeve 25 (in this case, five permanent magnets S2, N2, S1, N1 and S3 are arranged in a clockwise direction in this order). The sleeve 25 is structured such as to be rotated in a direction of an arrow in the drawing by a sleeve drive means (not shown).

### (3. Operation)

Next, a description will be given of an operation of the image forming apparatus in accordance with the structure mentioned above.

At a time of forming the image, a color print data obtained by reading the image or an image data output from a personal computer or the like is applied to a predetermined signal process, and is thereafter transmitted as an image signal of each of colors including yellow (Y), magenta (M), cyan (C) and black (Bk) to each of the image forming units 1Y, 1M, 1C and 1Bk.

In each of the image forming units 1Y, 1M, 1C and 1Bk, an image latent image is formed by projecting a laser light which is modulated by the image signal onto the photoreceptor drum 7. Further, the toner is fed to the photoreceptor drum 7 from the developing apparatus 9.

In the developing apparatus 9, the developer accommodated within the developer accommodating container 11 is circulated while being agitated, by rotatably driving the agitating screw 12 and the feeding screw 13. Further, the toner is fed from the feeding screw 13 to the developing roller 14, is scraped off by the regulating member lib so as to be set to a fixed amount, and is thereafter fed to the photoreceptor drum 7.

Accordingly, the toner images of yellow, magenta, cyan and black are formed respectively on each of the photoreceptor drum 7. The formed toner images of yellow, magenta, cyan and black are sequentially overlapped on the moving intermediate transfer belt 29 so as to be primarily transferred. The overlapping toner image formed on the intermediate transfer belt 29 as mentioned above is moved to the secondary transfer portion 31 in accordance with a movement of the intermediate transfer belt 29.

Further, the recording medium 33 is fed from the recording medium feeding unit 4. The fed recording medium 33 is fed to a portion between the secondary transfer portion 31 and the intermediate transfer belt 29 by the feed roller 34, and the toner image formed in the intermediate transfer belt 29 is transferred thereto. The recording medium 33 to which the toner image is transferred is further fed to the fixing unit 35, where the transferred toner image is fixed, and is thereafter discharged to the discharge tray 36.

In this case, in the developing apparatus 9, a feed state of the developer becomes as follows, at a time of rotatably driving the agitating screw 12 and the feeding screw 13.

In other words, rotating speeds of the agitating screw 12 and the feeding screw 13 are regulated by the control unit 6, for example, in accordance with a printing speed which is changed in correspondence to the kind of the recording medium 33. For example, in the case of a cardboard mode, the rotating speed is slowed.

Further, if the rotating speed is changed, there is a case that the liquid surface position of the developer greatly fluctuates which of the circulating paths the developer is positioned. The position of the liquid surface of the developer fluctuates in the communication portions 18a and 18b, however, a position of an opening upper end constructing the communication portions 18a and 18b is positioned in a lower side than a supposed lowest position of the liquid surface. Therefore, the amount of the developer passing through the communication portions 18a and 18b corresponds to an opening area. As a result, a flowing state of the developer becomes stable, and it is possible to suppress the fluctuation of the height of the liquid surface.

In accordance with the above mentioned embodiment, since the communication portion is made open in the lower side than the height of the liquid surface of the developer, it is possible to make a fixed amount of developer always pass through in accordance with the feeding speed by the feeding member, without being affected by the fluctuation of the height of the liquid surface of the developer. Accordingly, any deflection is not generated in the circulating direction of the developer, and it is possible to suppress the generation of the image unevenness, and the fluctuation of the torque load applied to the feeding member. Further, since only the opening position of the communication portion is changed, it is possible to simply and inexpensively manufacture.

In this case, the present invention is not limited to the structure described in the embodiment mentioned above, but can be variously modified.

For example, in the embodiment mentioned above, the developer discharge port 20 of the developer accommodating container 11 is formed in one end side of the second accommodating portion, however, may be provided in the middle of the circulating path of the second accommodating portion 17. In FIG. 6, the developer discharge port 20 is provided at the following position. In other words, a position in a vertical direction of the developer discharge port 20 is a position capable of discharging the developer on the basis of the fact that a liquid level of the developer within the developer accommodating container 11 goes beyond an upper limit value of a reference range which is thought to be proper. Accordingly, the developer going beyond the reference range in the second accommodating portion 17 is appropriately discharged, thereby preventing the deteriorated carrier from staying within the developer accommodating container 11 over a long period of time. Further, a position in a lateral direction of the developer discharge port 20 is in the vicinity of the upstream side of the communication portion 18b with respect to the flow direction of a developer.

Further, in the embodiment mentioned above, the communication portions 18a and 18b are structured such that the positions of their opening upper ends are positioned in the lower side than the supposed height of the liquid surface of the developer, however, the position of the opening upper end may be set to be a lower side than a straight line connecting centers of rotation of the agitating screw 12 and the feeding screw 13 as shown in FIG. 8. This is because it is thought that the height of the liquid surface generally becomes higher than the positions of the opening upper ends of the communication portions 18a and 18b within the amount of the developer accommodated in the developer accommodating container 11.

Further, in the embodiment mentioned above, the positions of the opening lower ends of the communication portions 18a and 18b are set to be above the lowest position of each of the accommodating portions 16 and 17, however, they may be set to the same position as the lowest positions of the accommodating portions 16 and 17. In accordance with this structure, it is possible to make the flowing state of the developer in the communication portions 18a and 18b smoother.

Further, in the embodiment mentioned above, both of the communication portions 18a and 18b are structured such that the positions of their opening upper ends are positioned in the lower side than the supposed height of the liquid surface of the developer, however, only the communication portion 18a positioned close to the developer discharge port 20 may be structured as mentioned above.

Further, in the embodiment mentioned above, the description is given of the case that the rotating speeds of the screws 12 and 13 are changed in correspondence to the thickness of the paper, as the factor by which the height of the liquid surface of the developer fluctuates, however, there is a case that the liquid surface fluctuates even in the case that the bulk density of the developer is changed, for example, the case that an environment is changed, a deterioration due to durability of the developer makes progress, the case that the high or low BW ratio print goes on, and the like. The present invention is useful even in the cases mentioned above.

Further, the structure of the image forming apparatus in accordance with the embodiment mentioned above can be applied to any equipment such as a full-color or monochrome copying machine, a printer, a facsimile, a complex machine thereof, and the like. Further, the structure thereof may be appropriately changed in correspondence to the used equipment.

What is claimed is:

1. A developing apparatus comprising:
a developer accommodating container having a replenishing portion in which a developer including a toner and a carrier is accommodated, and provided for replenishing the developer, and a discharging portion for discharging the accommodated developer;
said developer accommodating container being separated into a first accommodating portion and a second accommodating portion by a partition wall;
the first accommodating portion and the second accommodating portion being communicated with each other by communication portions in both end sides; and
the developing apparatus being structured such as to move in a circulating manner the accommodated developer while agitating, by means of a first feeding member arranged in the first accommodating portion and a second feeding member arranged in the second accommodating portion,
wherein said communication portions are communicated below a supposed lowest height of a liquid surface of the developer.

2. The developing apparatus as claimed in claim 1, wherein each of said first feeding member and said second feeding member are constructed by a screw in which a spiral blade is provided around a rotating shaft, and
wherein said communication portion is an opening formed in said partition wall, and a position of an opening upper end of said communication portion is positioned in a lower side with respect to a straight line connecting centers of rotation of said feeding members.

3. The developing apparatus as claimed in claim 1, wherein a discharge portion of said developer accommodating container is arranged in a downstream side in a feeding direction of the developer by any one of said feeding members,
wherein said feeding member is provided with a backflow portion flowing back a feeding direction of the developer in an upstream side of the discharge portion with respect to the feeding direction of the developer, and
wherein the communication portion formed in said discharge portion side is formed in a further upstream side of said backflow portion.

4. The developing apparatus as claimed in claim 1, wherein an angle which a straight line connecting centers of rotation of said feeding members forms with respect to a horizontal surface is set to be equal to or less than 30 degrees.

5. The developing apparatus as claimed in claim 1, wherein the position of the opening lower end of at least one communication portion which is positioned at the side of the discharging portion in the communication portions is upper to the lowest position of the each accommodating portion.

6. The developing apparatus as claimed in claim 1, wherein the position of the opening lower end of the communication portion is set to the same position as the lowest positions of the accommodating portions.

7. An image forming apparatus comprising the developing apparatus as claimed in claim 1.
